(19) United States
(12) Patent Application Publication
(10) Pub. No.: US 2009/0044780 A1
(43) Pub. Date: Feb. 19, 2009

(54) Special improved durability engine device for use with stationary power generation systems

(76) Inventor: Laura M. Soverns, Pendleton, IN (US)

Correspondence Address: RITCHISON LAW OFFICES, PC;John D. Ritchison, Suite A, 115 East Ninth Street, Anderson, IN, 46016-1509, US

(21) Appl. No.: 12/214,912

(22) Filed: Jun. 24, 2008

Related U.S. Application Data
(60) Provisional application No. 60/937,239, filed on Jun. 25, 2007.

(51) Int. Cl. F02F 1/42

(52) U.S. Cl. 123/193.5

(57) ABSTRACT

A new use for and improvements to a device for generating electricity from a stationary source. The device is comprised of a special Improved Durability Engine; a generator; a special valve seat; a means of rotation eliminator; a series of process improvements; and a group of significant material improvements to several critical components wherein the improvements provide improved durability to a natural gas fueled engine. The configuration includes design features, process controls, dimensional controls and material enhancements that provide superior durability and equipment life for the conversion machines to transfer natural gas or the like to electrical power and thermal energy. The critical elements work together to support head life of 16,000+ hours.

### CROSS-REFERENCE TO RELATED APPLICATIONS

This application claims the benefit of Provisional Patent Application Ser. No. 60/937,239 filed Jun. 25, 2007 by Laura M. Soverns and entitled “Special Improved Durability Engine Device for Use with Stationary Power Generation Systems”.

### FIELD OF INVENTION

This uniquely improved device relates to a special Improved Durability Engine for Use with Stationary Power Generation Systems. Particularly this new special Improved Durability Engine Device is related to significantly improved component, materials and methods to improve the overall life and durability of conversion engines that are used with natural gas and other fuels.

### FEDERALLY SPONSORED RESEARCH

None.

### SEQUENCE LISTING OR PROGRAM

None.

### BACKGROUND

### Field of Invention

A special Improved Durability Engine device has been developed for use with Stationary Power Generation Systems. Particularly this new special Improved Durability Engine Device is related to improved component, materials and methods to improve the overall life and durability of conversion engines that are used with natural gas and other fuels. One skilled in the art of gensets and stationary power conversion well appreciates the improvements to durability shown herein.

### A. Introduction of the Problems Addressed

The stationary power generation systems have been powered primarily by diesel and gasoline engines. The systems that are converted to natural gases or biologically produced alternatives such as methane and ethane, etc. have attempted to use existing gasoline and diesel powered engines. However, the change to a gas vapor system such as natural gas have revealed significant limitations in useful life—durability—prior to servicing the units. The improvements contained with this Soverns configuration and material uses greatly improve that durability for natural gas systems and the like.

### B. Prior Art

The first found mention of turbosets remotely related to the Soverns device begins with U.S. Pat. No. 4,002,023 issued to Hartman (1977). It describes a stationary power-generating plant of the type which includes a turboset comprising an axial-flow combustion gas turbine, an axial flow combustion air compressor and a driven machine such as an electrical generator which are all coupled together and mounted for rotation about a common axis. No major durability improvements are addressed nor are elements of Soverns invention anticipated.

A U.S. Pat. No. 4,487,014 issued to Vinciguerra (1984) teaches a Gas generator and turbine unit. Here a gas turbine power unit is disclosed in which the arrangement and configuration of parts is such as to save space and weight in order to provide a compact and self-contained assembly. No major durability improvements are addressed nor anticipated.

A series of gas Systems for use of land fills and recyclable materials are shown in three patents to issued to Wikstrom, et al. U.S. Pat. No. 6,938,439 (2005) shows how gases are vented from a waste site such as a landfill, and the gases are separated into at least three streams comprising a hydrocarbon stream, a carbon dioxide stream, and residue stream. At least a portion of the carbon dioxide stream and hydrocarbon stream are liquefied or converted to a supercritical liquid used for cleaning. A U.S. Pat. Nos. 6,554,170 (2005) and 7,389,654 (2008) show similar gas conversion treatment at land fills for cleaning. No major durability improvements are addressed nor anticipated.

As far as known, there are no other improved or enhanced engine devices at the present time which fully provide these durability improvements to the drive mechanisms and power sources for stationary power generation systems. It is believed that this device is made with improved configuration of physical connections, resulting in a more durable design, with a better process of preparation and assembly, and with better material selections as compared to other currently utilized power systems for stationary generation of electricity and production of hot water.

### SUMMARY OF THE INVENTION

A special Improved Durability Engine device has been developed for use with Stationary Power Generation Systems. Particularly this new special Improved Durability Engine Device is related to improved component, materials and methods to improve the overall life and durability of conversion engines that are used with natural gas and other fuels.

A new configuration has been developed for use with an 8.1 L gasoline powered engine or the like. The critical element for longer durability and field life are the cylinder heads. The “best in class” design, materials and assembly process will lead to the longest life for field use. The mass produced head castings are machined at a precision supplier and configured with a proprietary system of components. These components work together to support head life of approximately 16,000+ hours or more. This is at least a twofold increase to the present life of the engines when stationary and when powered by natural or LP gas.

The engine during operation is exposed to severe vibration, high levels of heat and corrosive materials from the fuel and water. These may be addressed by material selection, configuration of key parts such as the valves and seal, and dimensional control. Also, in the manufacturing operation, the preparation and assembly may expose the units to process irregularities that result in causing early wear and failures. This may be improved somewhat by material selection, configuration of key parts such as the valves and seats, and the dimensional control. Empirical test show that careful improvements to the preparation of the cylinder head assembly and “matching” of valves and seats can have significant improvement to durability capabilities and hence engine life.

The preferred embodiment of the special Improved Durability Engine Device is comprised essentially of improvements in four areas: material selection; process controls; special configurations of critical component parts for stationary natural gas units; and dimensional control of the component parts. The first improved change is Material Selection. The valves have special coatings and base materials. The seats have special base materials for improved life as described below. The second improved change is Process Controls such as the seat removal; seat insertion; seat contact with the register; exhaust guide interference and sealing; the lapping of valves and seats; removal of all debris in ports and registers; and checking heads with a vacuum or pressure test. The third improved change is with the Configurations of critical parts. The mating angles for valves and seats; the guide grooves; the cam configuration for smooth transition; the rotator spacer configured to eliminate rotation; and, preload on the valve spring by controlling its installed height. The fourth improved change is dimensional control of the component parts. These include items such as valve to seat concentricity; deck height; installed spring height; guide clearance; and valve to rocker arm angle. Several dimensions set for normal vehicle duty cycles are not precise enough to support the severe duty cycle of the stationary prime power generator fueled by natural or LP gas. These improvements are described in detail below.

### OBJECTS AND ADVANTAGES

There are several objects and advantages of the special Improved Durability Engine device. However, this new device has been developed for use with an 8.1 L standard gasoline powered. The device improvements enable this standard engine to be used with natural gas and the like. The overriding objective and empirical results are to achieve longer durability and field life on a consistent basis. These improvements offered by the special Improved Durability Engine device work together to support cylinder head life of approximately 16,000+ hours or more. This is at least a twofold increase to the present life of the engines when stationary and when powered by natural or LP gas.

Other advantages and additional features of the present special Improved Durability Engine device will be more apparent from the accompanying drawings and from the full description of the device. For one skilled in the art of devices and improvements for electrical power generation and the power sources and engines used to drive such systems, it is readily understood that the features shown in the examples with this mechanism are readily adapted for improvement to other types of engine drive systems.

### DESCRIPTION OF THE DRAWINGS

### Figures

The accompanying drawings, which are incorporated in and constitute a part of this specification, illustrate a preferred embodiment for the special Improved Durability Engine Device. The drawings together with the summary description given above and a detailed description given below serve to explain the principles of the special Improved Durability Engine Device. It is understood, however, that the device is not limited to only the precise arrangements and instrumentalities shown.

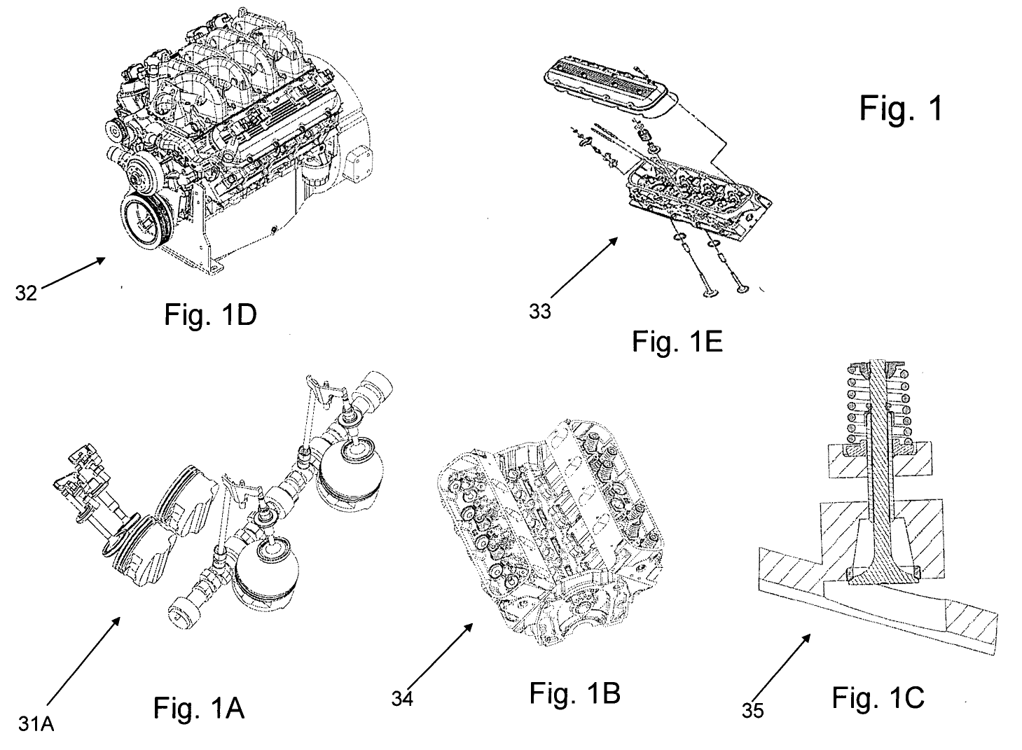

FIGS. 1A through 1E depict the special Improved Durability Engine Device for natural gas driven engines especially suited for generating electricity and hot water. General configurations of the new device and the existing prior art are shown.

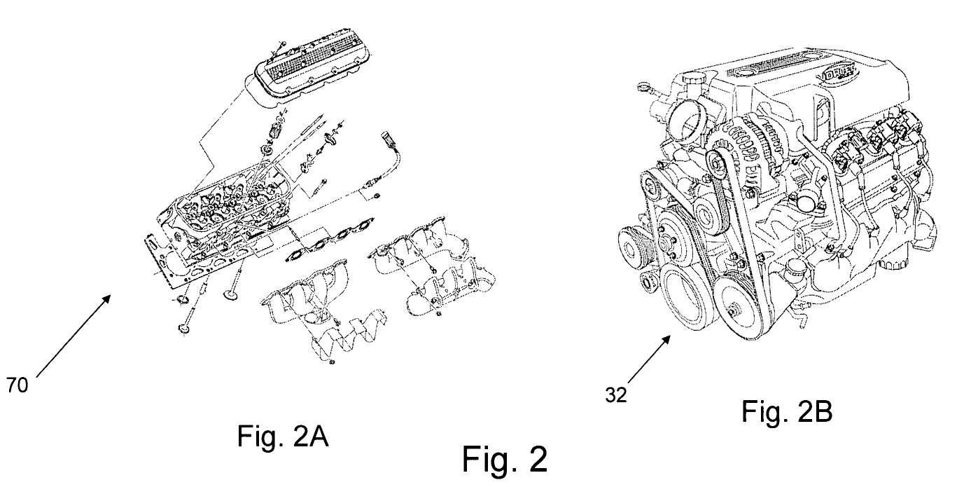

FIGS. 2 A and 2 B are isometric sketches and a bill of material for the 8.1 L engine assembly being improved with the unique special Improved Durability Engine Device.

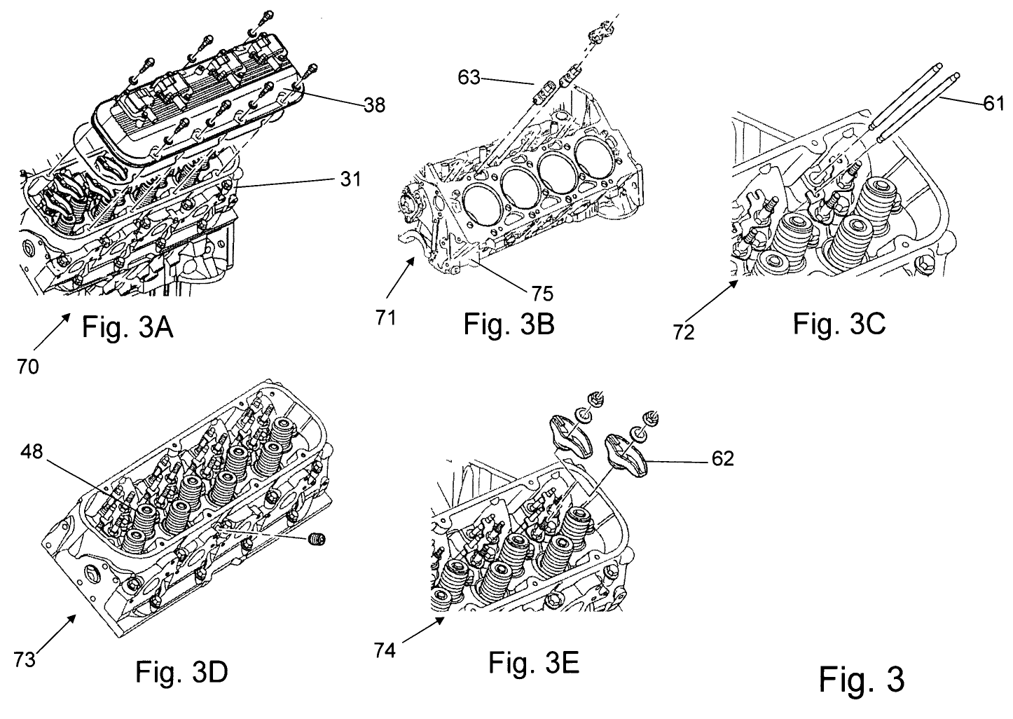

FIGS. 3 A through 3 E are the general isometric drawings for a standard gasoline engine such as an 8.1 L or the like.

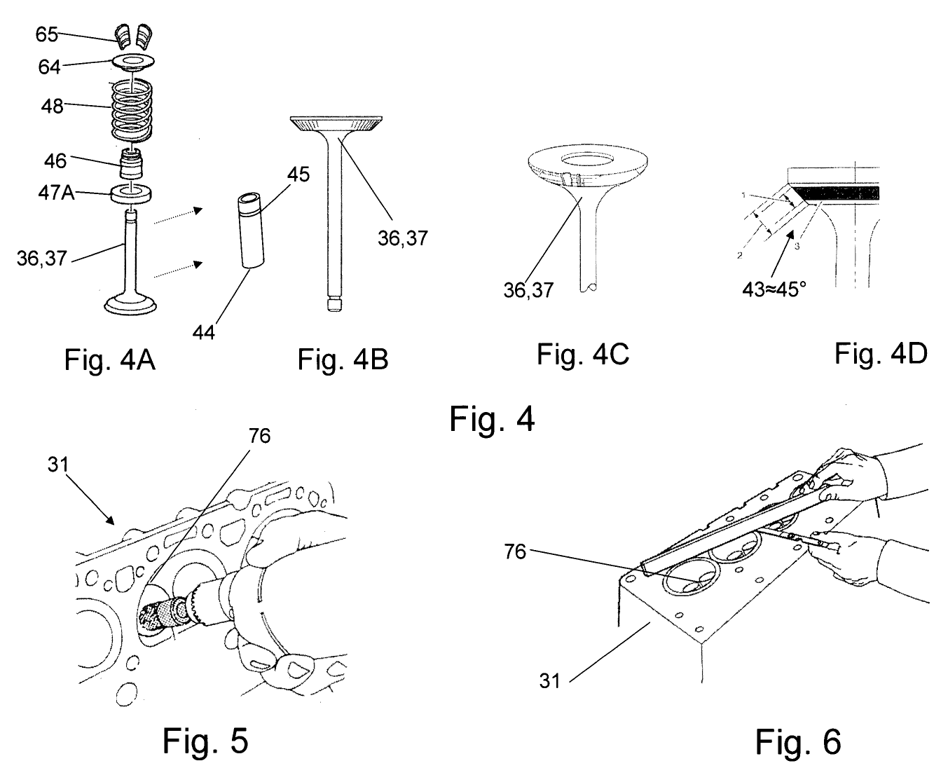

FIGS. 4 A through 4 D are component details of valve assemblies for standard gasoline engines such as the 8.1 Liter or the like.

FIG. 5 shows an isometric drawing for the cylinder block of an 8.1 liter or the like gasoline engine.

FIG. 6 is an isometric sketch of checking the flatness and register of an engine block.

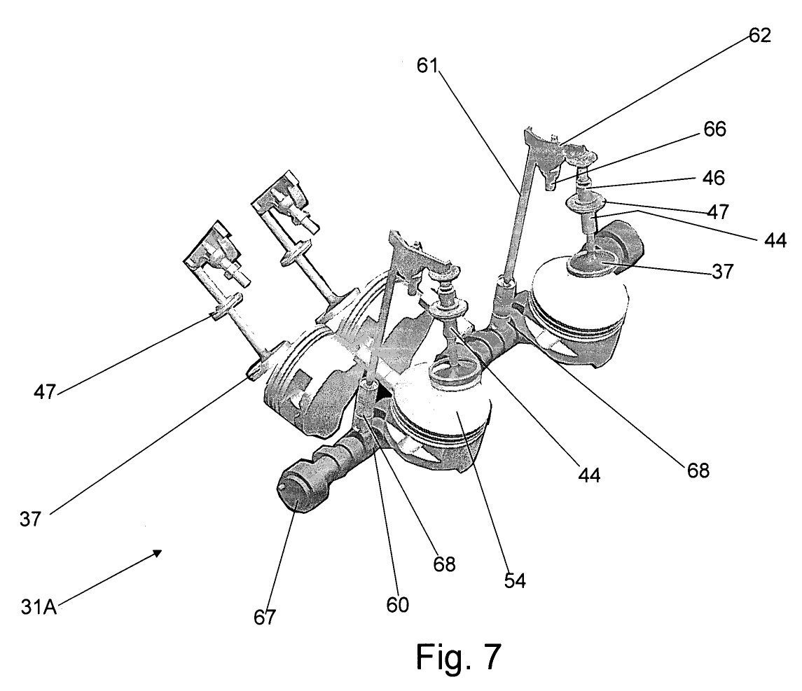

FIG. 7 is an isometric computer drawing of a typical cylinder head with the improvements comprised in the special Improved Durability Engine Device.

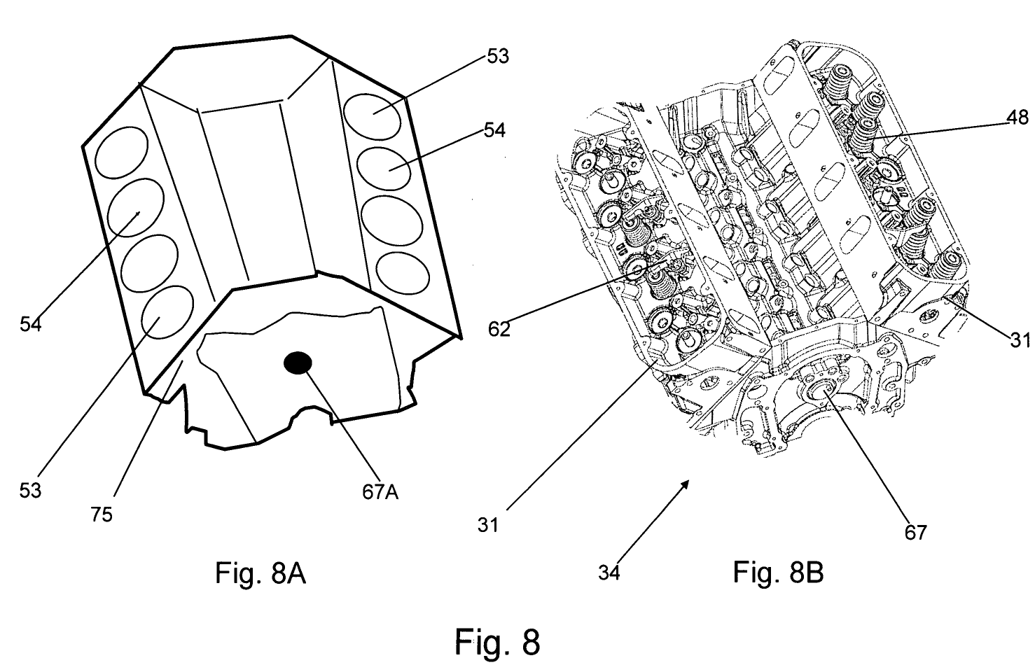

FIGS. 8 A and 8 B are computer sketches that show views of the engine block and cylinder head assembly of the special Improved Durability Engine Device.

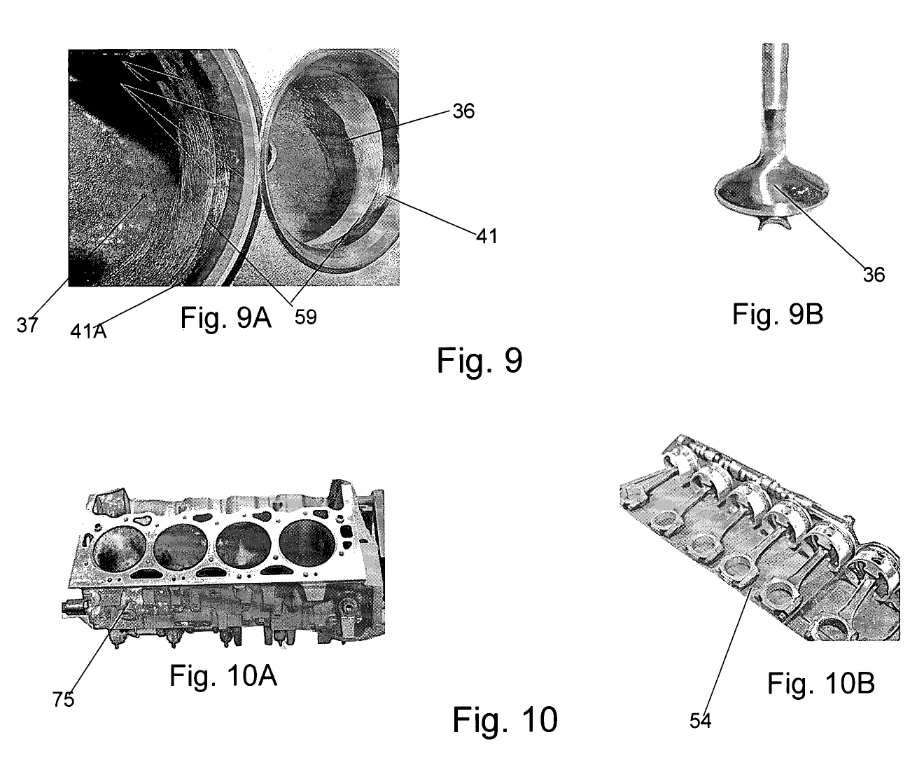

FIGS. 9 A and 9 B are photo-sketches that show valve interfaces with the engine blocks for the special Improved Durability Engine Device.

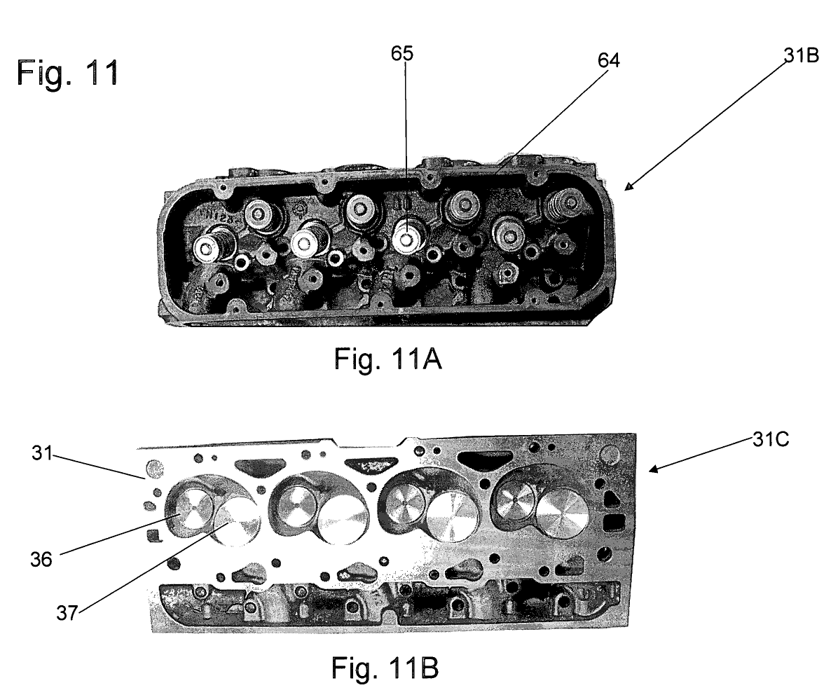

FIGS. 10 A and 10 B are photo-sketches of the engine block and pistons with connecting rods for the special Improved Durability Engine Device.

FIGS. 11 A and 11 B are photo-sketches of the cylinder heads from the rocker arm side and the valve side of the engine.

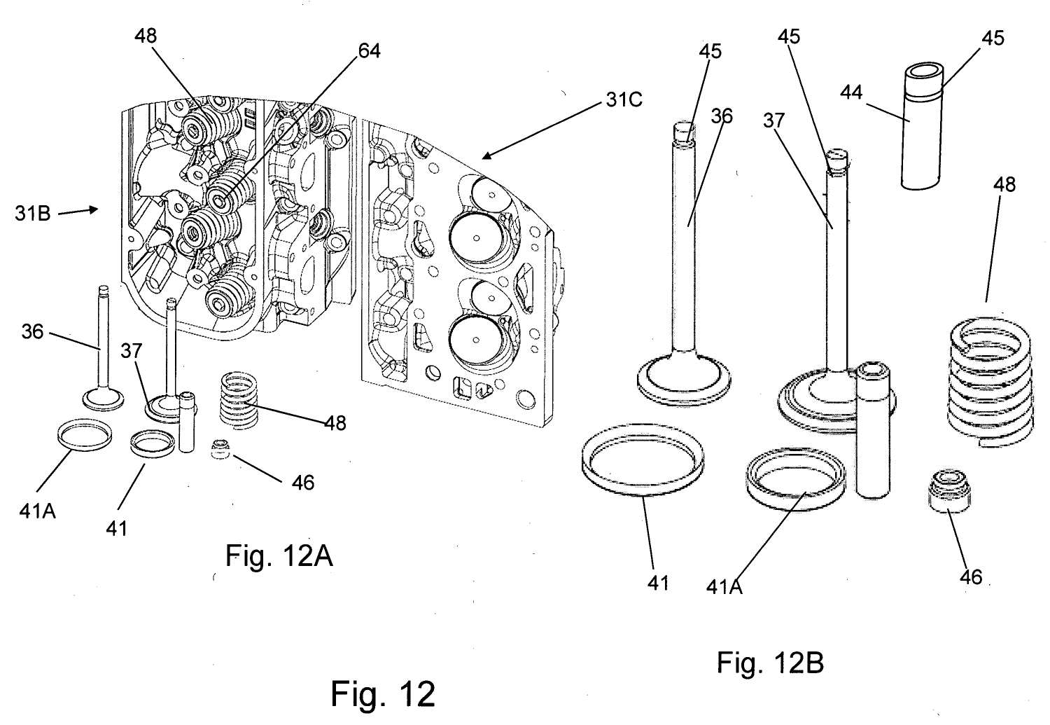

FIGS. 12 A and 12 B are photo-sketches of the various components comprising the special Improved Durability Engine Device.

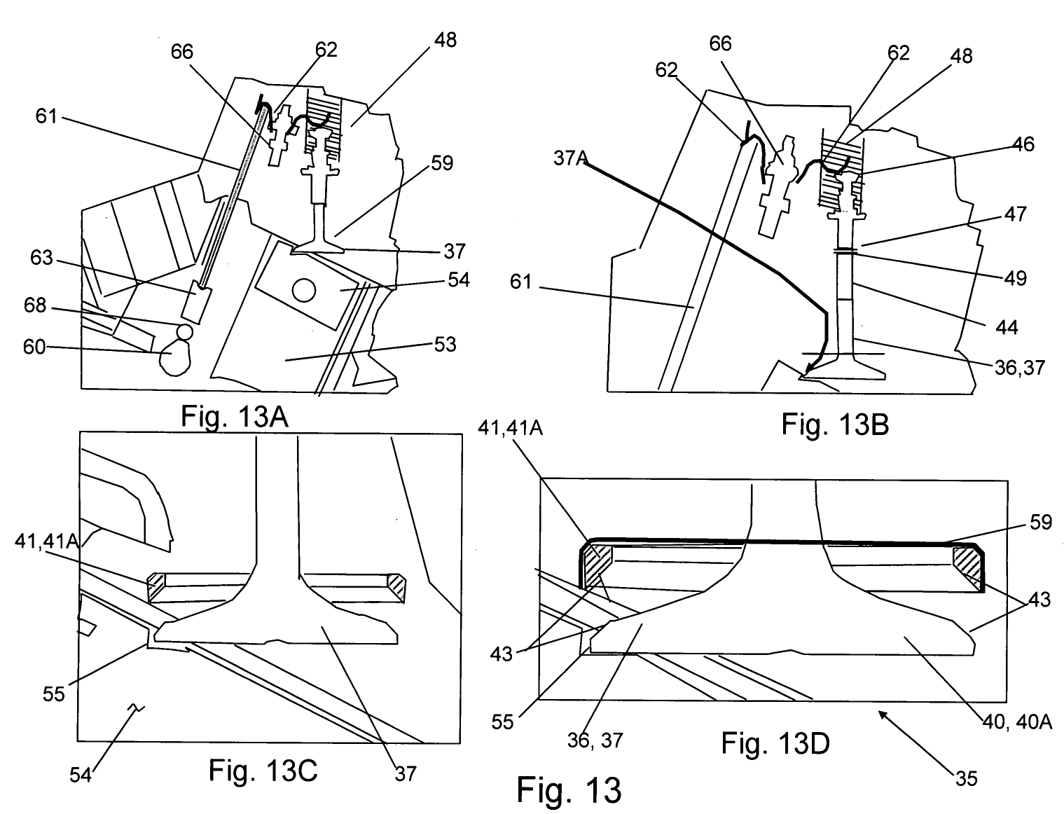

FIGS. 13 A through 13 D are computer simulated drawings of the components and features comprising the special Improved Durability Engine Device.

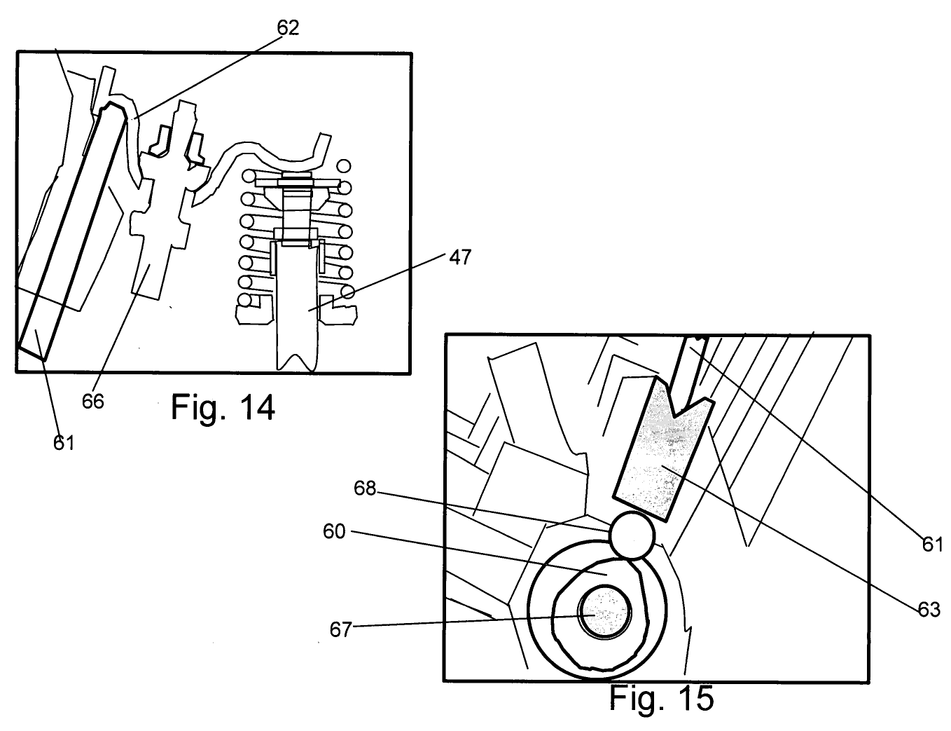

FIG. 14 is a computer simulation of the rocker arm transfer for the special Improved Durability Engine Device.

FIG. 15 is a computer drawing of the camshaft drive and inputs to activate the special Improved Durability Engine Device.

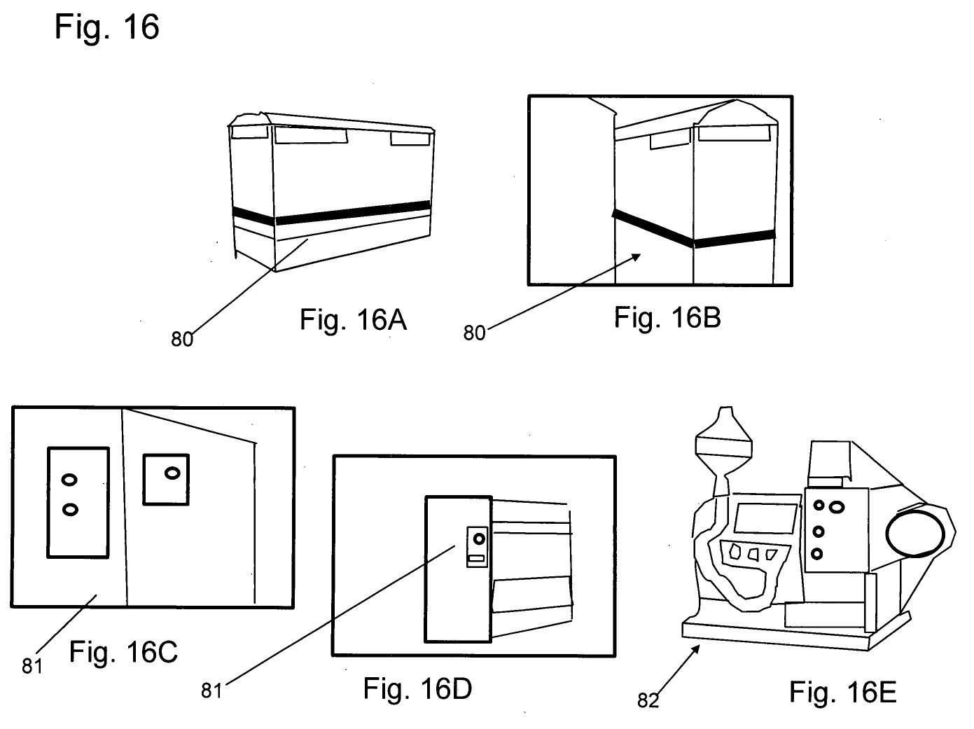

FIGS. 16 A through 16 E are photo-sketches of the final uses and products utilizing the special Improved Durability Engine Device.

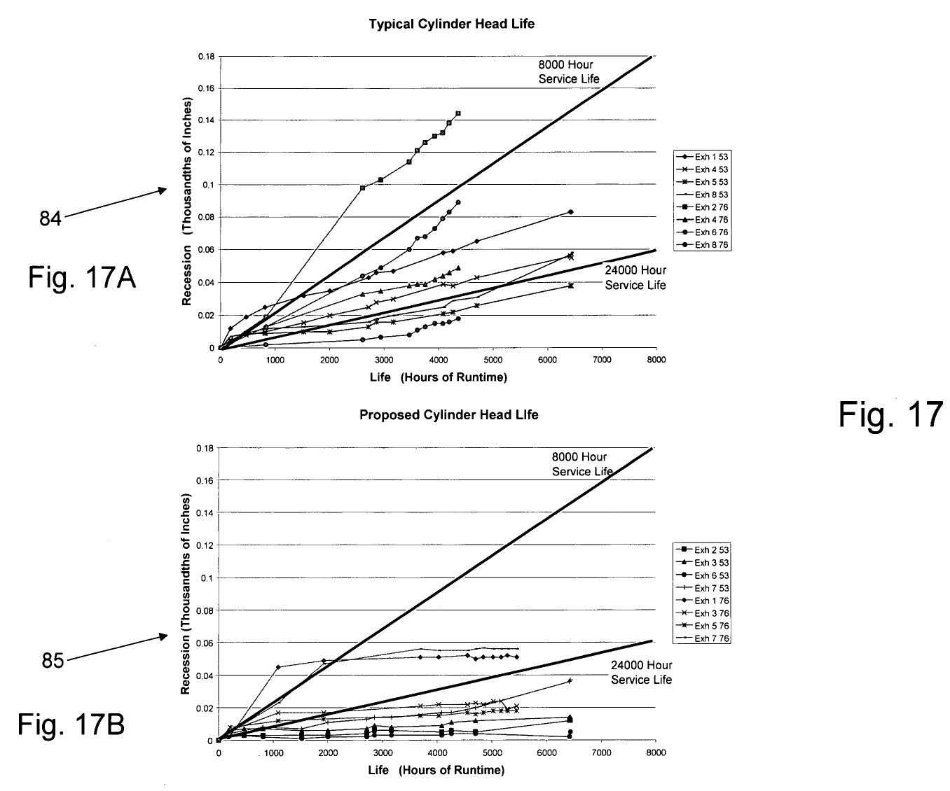

FIGS. 17 A and 17 B are charts of the before and after test data for the special Improved Durability Engine Device.

### DESCRIPTION OF THE DRAWINGS

### Reference Numerals

The following list refers to the drawings:

| Ref # | Description |
|---|---|
| 31 | General cylinder head for the Special Improved |
| | Durability Engine Device for Use with Stationary |
| | Power Generation Systems |
| 31A | Cylinder head component detail isometric |
| 31B | General cylinder head from the rocker arm vantage |
| 31C | General cylinder head from the piston side vantage |
| 32 | Engine assembly (e.g. 8.1 L or the like) |
| 33 | Service isometric for an 8.1 L or the like |
| 34 | Engine block with a cylinder head assembly |
| 35 | Valve and seat assembly |
| 36 | Exhaust valve |
| 37 | Intake valve |
| 37A | Intake port |
| 38 | Rocker Arm cover |
| 40 | Exhaust valve seat of valve body |
| 40A | Intake valve seat of valve body |
| 41 | Exhaust valve insert seat for cylinder head |
| 41A | Intake valve insert seat for cylinder head |
| 42 | Valve seat materials |
| 43 | Valve angle |
| 44 | Valve guide |
| 45 | Multiple groove on valve shaft |
| 45A | Single groove |
| 46 | Valve seal |
| 47 | Rotator eliminator means |
| 47A | Rotator spacer |
| 48 | Valve spring |
| 49 | Valve shims |
| 51 | Special lubricant |
| 52 | Anaerobic exhaust guide sealant |
| 53 | Combustion chamber |
| 54 | Piston and connecting rods |
| 55 | Piston aperture/eyebrow clearance for intake valve |
| 59 | Block register for the new device |
| 60 | Cam |
| 61 | Pushrod aka push tubes |
| 62 | Rocker arm |
| 62A | Rocker arm ball |
| 62B | Rocker arm nut/fastener |
| 63 | Valve lifter |
| 64 | Spring retainer |
| 65 | Keepers, locks |
| 66 | Rocker arm stud |
| 67 | Cam shaft |
| 67A | Cam shaft aperture |
| 68 | Cam follower/roller |
| 70 | Standard 8.1 liter engine diagram and parts list |
| 71 | Valve lifter assembly |
| 72 | Push rod assembly |
| 73 | Spring assembly |
| 74 | Rocker arm assembly |
| 75 | Engine block |
| 76 | Standard set register for 8.1 L engine |
| 80 | Outdoor electrical generator unit |
| 81 | Indoor electrical generator unit |
| 82 | Well pump drive electrical unit |
| 84 | Current production durability graph and data |
| 85 | Proposed durability production test unit's |
| | durability graph and data |

### DETAILED DESCRIPTION OF PREFERRED EMBODIMENT

The present mechanism is a special Improved Durability Engine Device 31. The preferred embodiment of the special Improved Durability Engine Device is comprised essentially of improvements in four areas: material selection; process controls; special configurations of critical component parts for stationary natural gas units; and dimensional control of the component parts.

There is shown in FIGS. 1-17 a complete operative embodiment of the special Improved Durability Engine Device 31. In the drawings and illustrations, one notes well that the FIGS. 1-15 demonstrate the general configuration of the present concept and the prior art for this invention. FIG. 16 show the operational uses and FIG. 17 show the empirical data that supports the change to this improved configuration described herein. These drawings and illustrations are described in detail below. The changes in the improved device are in four major areas. These changes will be described accordingly first before describing the illustrations.

The first improved change is Material Selection. The valves 36,37 and seats 41, 41A have special coatings and base materials 42. The exhaust 36 and intake 37 valves are proprietary valves manufactured exclusively for Lloyd's Machine Shop by the Eaton Corporation. These valves 36, 37 are used only in the I Power 8.1 L natural gas engine 32. The heads of both valves 36, 37 are coated with cobalt based, hardened material for HD valves (like Stellite-1® or the like). The exhaust valve 36 base material is inconel or the like for high temperature performance, and the stem is silchrome or the like. The base material of the intake valve 37 is a high grade intake material. The stems of both valves 36, 37 are chrome plated to minimize friction and retain oil. The seat 41, 41A insert is a sintered tungsten carbide tool steel with additives to improve its high hot hardness for use in natural gas engines. Solid lubricants are built in to the material to prevent micro-welding which is the primary cause of valve recession. Special processing techniques are used for producing the seats 41, 41A. These include high temperature sintering and post heat treat processing which create “cermet” style metal alloy oxides in the material. They are called “cermet” because they do not soften at elevated temperatures (which is similar to ceramics), but they retain the machinability (which relates to metals). The preferred example of a seat 41, 41A (as an example and not a limitation) is called the 90000 series by its maker, the Dura-Bond Bearing Company of Carson City, Nev. The valve guides 44 are made of a high strength cast iron or the like with elements added for lubricity. The top end of the guide has a double groove feature 45 that mates directly with the radiused bands of the valve seal 46. This feature prevents the valve seal 46 from coming off of the guide 44 during operation, which could result in a guttered valve 36, 37 due to too much oil reaching the valve seat 40, 40A surface area or the seats 41, 41A themselves. The rotator eliminator spacer 47 is made of a sintered metal composition similar to that of valve guides 44. The valve spring 48 is made specifically for use in LPG/natural gas engines 32. It is made of a valve grade material. The preload on the spring 32 is determined by its installed height.

The second improved change is Process Controls. Several processing practices have a distinct effect on the durability of the cylinder head 31. Many processes will result in poor heat rejection in the completed cylinder head 31 if not done properly. In fact, all of the process controls listed below were discovered through failure analysis of actual cylinder heads 31.
1) The seat 41, 41A insert must be installed against a flat, clean, undamaged engine block register 59. This means that removal of a previously installed seat must not damage or warp the register.
2) The seat 41, 41A must make contact with the register 59 around the entire circumference of the seat 41, 41A. This helps to assure good contact of the valve seat area 40, 40A with the seats 41, 41A.
3) Since the exhaust guide 44 crosses through the water jacket, it must be inserted with a coating of anaerobic sealer 52 or the like to prevent coolant leaks into the combustion chamber 53.
4) The guides 44 must be inserted with a maximum interference of approximately 0.0022″ to prevent cracking the head material in the guide area.
5) The valves 36, 37 must be lapped.
6) Debris must be cleaned out of all ports, especially the register 59 prior to inserting the seat 41, 41A.
7) The heads 31 must be vacuum checked for sealing prior to shipping to the user (I Power or another company).

The third improved change is with the Configurations of critical parts. The mating angles for valves 36, 37 and seats 41, 41A; the guide grooves 45; the cam 60 configuration for smooth transition; the rotator spacer 47 configured to eliminate rotation; and, preload on the valve spring 48 by controlling its installed height. The heads of both valves 36, 37 have a mating angle 43 between 15 and 45 degrees. The preferred embodiment has a mating angle 43 of approximately 30 degrees (for example and not limitation). The exhaust valve 36 is a 2 piece valve with a mid stem weld. The top end of the guide 44 has a double groove 45 feature that mates directly with the radiused bands of the valve seal 46. The cam 60 used in the I Power engine is specially designed for industrial applications. In place of the rotator spacer used by GM, the special Improved Durability Engine device uses a rotator eliminator spacer 47. The rotator eliminator 47 is made of a sintered metal composition or the like similar to that of valve guides 44. The valve spring 48 is made specifically for use in LPG/natural gas engines 32. It is made of a valve grade material. The preload on the spring 48 is determined by its installed height. Other valve train components used in the special Improved Durability Engine device 31 8.1 L natural gas engine 32 are standard OEM parts, including the push rod 72, the rocker arm 62 (with rocker ball 62A and nut 62B), the lifter 63, the spring retainer 64, and locks 65 (sometimes called “keepers”).

The fourth improved change is dimensional control of the component parts. Some dimensions of components in the special Improved Durability Engine device 31 greatly affect its durability. The identification of these dimensions is an empirical and analytical process that reveals the overall opportunities for improvement. Some dimensional controls that have been identified as important to the durability are: Valve 36,37 (seating area 40, 40A) to seat 41, 41A concentricity;

deck height;

installed spring 48 height;

guide 44 clearance; and

valve 36, 37 to rocker arm 62 angle.

In several cases, the dimension given by General Motors is satisfactory for passenger vehicle duty cycles, but is not precise enough to support the severe duty cycle of the prime power generator.

The accompanying drawings, which are incorporated in and constitute a part of this specification, illustrate a special Improved Durability Engine device 31 that is preferred. The drawings together with the summary description given above (especially as to materials and configurations) and a detailed description given below of the drawings and illustrations serve to explain the principles of the special Improved Durability Engine device 31. It is understood, however, that the special Improved Durability Engine device 31 is not limited to only the precise arrangements and instrumentalities shown.

FIGS. 1 A through 1 E depict the special Improved Durability Engine Device 31 for natural gas driven engines 32 especially suited for generating electricity and hot water. General configurations of the new device 31 and the existing prior art are shown. The general cylinder head assembly 31A is shown in FIG. 1A. In FIG. 1 B, the engine block 75 with the cylinder head assembly 34 is shown. FIG. 1C is a close-up view of the general view of the valve 36, 37 and seat 41, 41A assembly 35. FIG. 1 D is the general engine assembly 32. FIG. 1 E shows a simple service isometric 33 of parts used in an 8.1 Liter engine 32.

FIG. 2 A is an isometric sketch 70 and a bill of material for the 8.1 L engine assembly being improved with the unique special Improved Durability Engine Device 31. FIG. 2 B is a sketch of an 8.1 Liter engine 32. Both are from service manuals for the GM engine and serve as examples of the base design being improved by the special Improved Durability Engine device 31.

FIGS. 3 A through 3 E are the general isometric drawings for a standard gasoline engine 32 such as an 8.1 L or the like. FIG. 3 A is a standard GM isometric 70 with the cylinder head 31 and the rocker arm cover 38 depicted. FIG. 3 B shows the isometric of the valve lifter assembly 71, depicting the engine block 75 and valve lifters 63. FIG. 3 C depicts the push rod assembly 72 with the push rods 61 (aka push tubes) shown. FIG. 3 D shows the spring assembly 73 with several springs 48 depicted. FIG. 3 E is the rocker arm assembly 74 with rocker arms 62 shown in the view.

FIGS. 4 A through 4 D are component details of existing valve assemblies 36, 37 for standard gasoline engines 32 such as the 8.1 Liter or the like. These are references for the improvements discussed throughout this description. FIG. 4 A show the various components including the valves 36, 37; the rotator 47A; the valve seal 46; the spring 48; the spring retainer 64; the keepers 65; the guide 44; and the grooves 45. FIGS. 4 B and C show views or the valves 36, 37. FIG. 4 D shows the standard valve angle 43 of approximately 45 degrees.

FIG. 5 shows an isometric drawing for the engine block 75 and the standard engine register area 76.

FIG. 6 is an isometric sketch of checking the flatness and register 76 of an engine block 75. This is for reference in the description of the improvements shown by the special Improved Durability Engine device 31.

FIG. 7 is an isometric computer drawing of a typical cylinder head 31A with the improvements comprised in the special Improved Durability Engine Device 31. This view of the cylinder heads 31A of an 8.1 liter or the like gasoline engine 32 show no springs 48, guides 44, or casting 75. However other components of the assembly are clear. These include the intake valve 37. The rotator eliminator 47 is shown on the valve stems. The driving cam shaft 67, cam 60 and follower 68 are depicted as the driver of the works. The piston 54 is also shown. Other depictions are the push rod 61, rocker arm 62, and rocker retention stud 66. The valve seal 46 is shown in the view on the guide 44. The guide 44 would be inside the casting 75 providing a pathway for the lubricant for the valve stems 36, 37.

FIGS. 8 A and 8 B are computer sketches that show views of the engine block casting 75 and cylinder head assembly 31A of the special Improved Durability Engine Device 31. In FIG. 8 A the pistons 54 are shown as well as the combustion chambers 53 when the pistons are graphically removed. The aperture 67A for the cam shaft 67 is included. In FIG. 8 B, the general engine block with head assembly 34 is depicted. Here is shown a cross section of the rocker arms 62, springs 48, head assembly 31A and cam shaft 67.

FIGS. 9 A and 9 B are photographs that show valve 36, 37 interfaces with the engine blocks 75 at the registers 59 for the special Improved Durability Engine Device 31. As described in the process controls, this is critical to get the seats 41, 41A well placed in the registers 59. This will add to the life by having better interface of the seats 41, 41A and the valve seat areas 40, 40A on the valves 36, 37.

FIGS. 10 A and 10 B are photographs of the engine block 75 and pistons 54 with connecting rods for the special Improved Durability Engine Device 31. These photographs are self explanatory.

FIGS. 11 A and 11 B are photographs of the actual cylinder heads 31A from the rocker arm side 31B and the valve side 31C of the engine 32. Components shown are the spring retainer 65, springs 64, the bottom portion of the exhaust valves 36 and the intake valves 37.

FIGS. 12 A and 12 B are photographs of the various components comprising the special Improved Durability Engine Device 31. Views shown here are the cylinder heads 31A from the rocker arm side 31B and the valve side 31C of the engine 32. Components shown in the views and separately include the are the spring retainer 65, springs 64, the exhaust valves 36, the intake valves 37, the seats 41, 41A, and the valve seal 46.

FIGS. 13 A through 13 D are computer simulated drawings of the components and features comprising the special Improved Durability Engine Device 31. FIG. 13 A shows the full overview of the cylinder head assembly 31A. The mechanism is driven by the cam 60 on the camshaft 67 (not shown) rotating and moving the cam follower 68. This rotational movement of the cam 60 results in linear movement by the roller 68 as the lobe of the cam 60 rotates around the shaft 67. The roller is connected to the valve lifter 63 which drives the push rod 61 essentially up and down. The push rod 61 in turn actuates the rocker arm 62 which in turn transfers the movement to the valves 36, 37. These valves 37 and 36 open and shut at the seats 41, 41A and essentially open the intake ports and exhaust ports to the combustion chamber 53 as the piston 54 moves. This permits a fuel mixture to enter the intake ports when the intake valve 37 opens or permits the exhaust port to open when the exhaust valve 36 opens and permits exhaust gases to leave the chamber 53. FIG. 13 B shows a closer view of the assembly and depicts the same components plus the spring 48, the valve seal 46, the rotator eliminator means 47, and any required spacers 49. FIG. 13 C is a close-up that depicts the seats 41, 41A in the register 59 and the aperture (eyebrow clearance) on the pistons 54 at the intake valves 37. FIG. 13 D shows the close-up of the valves 36, 37 and the seats 41,41A inserted into the register 59. One may also note the valve seat areas 40, 40A. Critical improvement is obtained by matching the angles 43 of the seats 41, 41A and the valves 40, 40A to the approximate 30 degrees configuration as described above. It is important that on the exhaust guides there is an anaerobic sealant 52 to seal around the water chamber to prevent any intrusion of water.

FIG. 14 is a computer simulation of the rocker arm 62 transfer for the special Improved Durability Engine Device 31. The push rods 61 transfer motion through the rocker arm 62 and onto the valve 36, 37. The rocker arm 62 is held fixed near its center by the stud 66. In turn the push rod 61 moves the arm 62 in on direction and the motion is transferred in the opposite direction to the valves 36, 37. One may note the rotation eliminator means 47 keeps the valves from rotating and causing wear and potential leaks.

FIG. 15 is a computer drawing of the camshaft drive 67 and inputs to activate the special Improved Durability Engine Device 31. The camshaft 67 turns the cam 60 which is “followed” by the roller 68 as the cam 60 lobe rotates. This in turn moves the lifter 63 in a lineal motion and moves the push rods 61.

FIGS. 16 and 17 are described below.

All of the details mentioned here are exemplary and not limiting. Other specific components specific to describing a special Improved Durability Engine Device 31 may be added. For one skilled in the art of devices and improvements for electrical power generation and the power sources and engines used to drive such systems, it is readily understood that the features shown in the examples with this mechanism are readily adapted for improvement to other types of engine drive systems

### Operation of the Preferred Embodiment

The special Improved Durability Engine Device 31 has been described in the above embodiment. The manner of how the device operates is described below. One skilled in the art and field of electrical power generation and the drive engines for those systems will note that the description above and the operation described here must be taken together to fully illustrate the concept of the special Improved Durability Engine Device 31.

The operation of the preferred embodiment of the special Improved Durability Engine Device 31 is easily comprehended. The changes are incorporated in the manufacturing of the above described component parts and the preparation and assembly of the parts. The improvements to the process were described above.

The use and results of the improvements are described in FIGS. 16 and 17. FIGS. 16 A through 16 E are photographs of the final uses and products utilizing the special Improved Durability Engine Device. FIGS. 16 A and B show the typical outdoor electrical generator unit 80. It is powered by the special Improved Durability Engine device 31 described above. FIGS. 16 C and D show the typical indoor electrical generator unit 81. It is powered by the special Improved Durability Engine device 31 described above. FIG. 16 E show a well pump drive 82. It is powered by the special Improved Durability Engine device 31 described above.

For a clear understanding of the empirical results in the testing of the special Improved Durability Engine device 31 an explanation and introduction to an early and exemplary case study may be helpful. The exemplary recipe (and not offered as a limitation) is multi-faceted: it consists of a combination of material choices, process disciplines, and dimensional control.

Valve Recession may be used as a Durability Metric A cylinder head 31A fails due to the gradual degradation of its ability to seal up the combustion chamber 53. The gradual wear of the valve seat 41, 41A and the head insert seat results in a leak that eventually prevents efficient combustion. This leak is the End of Life for the cylinder head 31A. Industry experts define the end of life as 0.180 inches or more of valve recession within one year or approximately 8000 hours of operation. If the valve recession trend runs below the line created by this specification, the cylinder head 31A is expected to last at least through one year of service life. Other lines can be drawn to indicate increased cylinder head life. Two years of cylinder head life is represented by the line from the origin to 0.180″ at 16,000 hours; three years is 0.180″ at 24,000 hours, and so on.

A case study is shown before and after the improvements. In FIG. 17 A the expected cylinder head life 84 on a typical or standard genset prior to the implementation of the special Improved Durability Engine device 31 is shown. As Typical Chart 84 shows, the design is one valve short of reaching the one year service life goal, with a second valve close behind for Unit 76. The other unit, Unit 53, is maintaining a steady slope well below the one year service life line.

FIG. 17B shows an improved chart 85 of valve recession measured on heads using special Improved Durability Engine device components and running in parallel (on the same engines) with the standard components shown in FIG. 17A. The improvement is obvious in the general shallow slope of most valves. In addition, in the case where two valves experienced steep recession initially, the recession appears to have been arrested after a break in period. This phenomenon has been repeated multiple times on special Improved Durability Engine devices 31.

A further example in the case study is a Rank Order Analysis. To analyze the durability results of these two gensets, the data was organized into a Rank Order Analysis as for a partial factorial. Taking Unit 53, two corner and two center cylinders had been built with a powdered metal seat insert called the 90000 series made by Dura-Bond. The remaining two corner and two center cylinders had been built with a hardened steel seat made from J-loy or the like material, which was the current production seat at the time. J100 is a nickel based alloy with high chromium content. Parameters that remained constant among all cylinders were valve angle, valve seat material, and spring pressure.

| | | |
|---|---|---|
| Unit 53 | Novi | 6435 hrs |
| | #3 | |
| | 30E, 30I Eaton | |
| | Valves | |
| | GM seal | |
| | J100 seat = cylinders 1, 4, 5, 8 | |
| | 90K Dura-Bond seat = cylinders 2, 3, 6, 7 | |

| | | RANK | | | |
|---|---|---|---|---|---|
| Cyl- | | ORDER ANALYSIS | | | |
| inder | EXHAUST | Cyl- | EXHAUST | | |
| Num- | RECESSION | inder | RECESSION | SEAT | |
| ber | (.001″) | Number | (.001″) | TYPE | ROTATION |
| 1 | 0.083 | 6 | 0.005 | 90K | NONE |
| 2 | 0.012 | 2 | 0.012 | 90K | NONE |
| 3 | 0.014 | 3 | 0.014 | 90K | NONE |
| 4 | 0.055 | 7 | 0.037 | 90K | ROTATED |
| 5 | 0.038 | 5 | 0.038 | J100 | NONE |
| 6 | 0.005 | 4 | 0.055 | J100 | ROTATED |
| 7 | 0.037 | 8 | 0.058 | J100 | ROTATED |
| 8 | 0.058 | 1 | 0.083 | J100 | ROTATED |

As the cylinders were arranged in order from lowest recession to highest recession, it became obvious that the Dura-Bond 90K seat outperformed the J-loy J100 seat by a unanimous margin, showing a perfect end count.

Comparison of the worst Dura-Bond valve with the best J100 valve revealed that one valve had signs of rotating and the other did not. This prompted observation of all the valves for signs of rotation. Interestingly enough, within the same seat type family, the best valves had no signs of rotation and the worst valves had obviously rotated. This led to an investigation of the factors that cause a valve to rotate. Some rotation of a valve is necessary to knock off built up oil deposits on the valve seat. But, rotation can be detrimental when it becomes constant or severe. The valve begins to imitate a honing machine, and recession failure is imminent. Work is ongoing to identify stack up dimensions between the valve and rocker arm that encourage rotation of the valve. Once the root cause is identified, controls can be put in place to prevent the type of rotation that leads to early recession failure.

The secret recipe for long life cylinder heads consists of three important factors. All three essentially must be present to produce record setting durability for the stationary natural gas engine of the genset. The three factors are material compatibility, process controls, and dimensional controls.

Materials are the first ingredient. The exhaust and intake valves are proprietary valves manufactured by Eaton Corporation. They are used only in the 8.1 L natural gas engine. The head of both valves is coated with Stellite-1 (cobalt based, hardened material for HD valves) and has a 30 degree mating angle. The exhaust valve is a 2 piece valve with a mid stem weld. The exhaust base material is inconel for high temperature performance, and the stem is silchrome. The base material of the intake valve is a high grade intake material. The stem of both valves is chrome plated to minimize friction and retain oil. The seat insert is a sintered tungsten carbide tool steel with additives to improve its high hot hardness for use in natural gas engines. Solid lubricants are built in to the material to prevent micro-welding which is the primary cause of valve recession. Special processing techniques including high temperature sintering and post heat treat processing create “cermet” style metal alloy oxides in the material. They are called “cermet” because they do not soften at elevated temperatures, which is similar to ceramics, but they retain the machinability of metal. The seat is called the 90000 series by its maker, the Dura-Bond Bearing Company of Carson City, Nev. The valve guides are made of a high strength cast iron with elements added for lubricity. The top end of the guide has a double groove feature that mates directly with the radiused bands of the valve seal. This feature prevents the valve seal from coming off of the guide during operation, which could result in a guttered valve due to too much oil reaching the valve seat surface. In place of the rotator spacer used by GM, I Power uses a rotator eliminator spacer. It is made of a sintered metal composition similar to that of valve guides. The valve spring is made specifically for use in LPG/natural gas engines. It is made of a valve grade material. The preload on the spring is determined by its installed height. The cam used in the I Power engine is specially designed for industrial applications. Other valve train components used in the 8.1 L natural gas engine are standard OEM parts, including the push rod, the rocker arm (with rocker ball and nut), the lifter, the spring retainer, and locks (sometimes called “keepers”).

Process controls are the second ingredient. Several processing practices have a distinct effect on the durability of the cylinder head. Many processes will result in poor heat rejection in the completed cylinder head if not done properly. In fact, all of the process controls listed below were discovered through failure analysis of actual cylinder heads. These are:
1) The seat insert must be installed against a flat, clean, undamaged register.
2) The seat must make contact with the register around the entire circumference of the seat.
3) Since the exhaust guide crosses through the water jacket, it must be inserted with a coating of anaerobic sealer to prevent coolant leaks into the combustion chamber.
4) The guides must be inserted with a maximum interference of 0.0022′ to prevent cracking the head material in the guide area.
5) The valves must be lapped.
6) Debris must be cleaned out of all ports, especially the register prior to inserting the seat.
7) The heads must be vacuum checked for sealing prior to shipping to I Power.

Dimensional Controls are the third ingredient. Some dimensions in the I Power valve train greatly affect the durability of the cylinder head. Some examples that have been identified to date are valve to seat concentricity, deck height, installed spring height, guide clearance, and valve to rocker arm angle. In several cases, the dimension given by the vehicle manufacturer for their engine requirements is satisfactory for passenger vehicle duty cycles, but is not precise enough to support the severe duty cycle of the prime power generator.

A summary of this exemplary case study shows that thousands of hours of durability testing have pinpointed the material choices, process controls, and dimensional characteristics that have a high impact on cylinder head life. This knowledge has directed procedures and tolerances for optimum quality from our cylinder head suppliers. The result is extended service life for the genset and stationary power device.

With this description it is to be understood that the special Improved Durability Engine Device 31 is not to be limited to only the disclosed embodiment. The features of the special Improved Durability Engine Device 31 are intended to cover various modifications and equivalent arrangements included within the spirit and scope of the description.

What is claimed is:

1. A special Improved Durability Engine device 31 for powering a stationary electrical generator with unique improvements comprised of
(a) a drive engine comprised of an engine block; an engine head; at least one exhaust valve with a stem; at least one intake valve with a stem; a coolant chamber; a register for matching to various components such as a valve; and means to interconnect and secure the components;
(b) a generator;
(c) a special valve seat 41;
(d) a means of rotation eliminator 42;
(e) at least one process improvements; and
(f) at least one significant material improvements to several critical components
wherein the improvements provide improved durability to a natural gas fueled engine.

2. The system according to claim 1 wherein the process improvement is installing the valve seat insert against a flat, clean, undamaged register.

3. The system according to claim 1 wherein the process improvement is a means to assure the seat make contact with the register around the entire circumference of the seat.

4. The system according to claim 1 wherein the process improvement is a coating of an anaerobic sealer on an exhaust guide of the engine to prevent coolant leaks into a combustion chamber of the engine.

5. The system according to claim 1 wherein the process improvement is lapping the valves.

6. The system according to claim 1 wherein the process improvement is to clean out debris from all ports of the engine.

7. The system according to claim 1 wherein the process improvement is pressure tests on the engine heads prior to assembly.

8. The system according to claim 1 wherein the material improvement is the valve heads are coated with Stellite-1 (cobalt based, hardened material for HD valves) and have a 30 degree mating angle.

11. The system according to claim 1 wherein the material improvement is the base material for an exhaust valve is inconel.

10. The system according to claim 1 wherein the stem of both valves is chrome plated
